(19) United States
(12) Patent Application Publication
(10) Pub. No.: US 2014/0347728 A1
(43) Pub. Date: Nov. 27, 2014

(54) OPTICAL MEMBER AND DISPLAY DEVICE INCLUDING THE OPTICAL MEMBER

(71) Applicant: Samsung Display Co., Ltd., Yongin-City (KR)

(72) Inventor: Duk-jin LEE, Suwon-si (KR)

(73) Assignee: Samsung Display Co., Ltd., Yongin-City (KR)

(21) Appl. No.: 14/059,290

(22) Filed: Oct. 21, 2013

(30) Foreign Application Priority Data
May 22, 2013 (KR) 10-2013-0057808

(51) Int. Cl. G02B 5/30

(52) U.S. Cl. CPC G02B 5/3083
USPC 359/489.07

(57) ABSTRACT

An optical member includes a polarization film configured to polarize light. The optical member may further include a sealing member that overlaps the polarization film. The optical member may further include a retardation film disposed between the polarization film and the sealing member and configured to cause phase retardation. The optical member may further include a lens film disposed between the retardation film and the sealing member and includes a plurality of concave lens units that defines a plurality of air units, which may be sealed by the sealing member.

### CROSS-REFERENCE TO RELATED APPLICATION

This U.S. non-provisional patent application claims priority under 35 U.S.C. §119 of and benefit of Korean Patent Application No. 10-2013-0057808, filed on May 22, 2013, the contents of which are hereby incorporated by reference in its entirety.

### BACKGROUND

1. Field of the Invention

The present invention relates to an optical member and a display device that includes the optical member.

2. Description of the Related Art

A display device may include one of various display panels, such as an organic light emitting display (OLED) panel, an electrophoretic display (EPD) panel, an electrowetting display (EWD) panel, and a liquid crystal display (LCD) panel, etc.

In general, a conventional display device may provide images with satisfactory image display quality when a viewer views the display panel in a direction that is substantially perpendicular to a display surface of the display panel. Nevertheless, the user may perceive images with unsatisfactory image display quality when the viewer views the display panel in a direction that is not substantially perpendicular to the display surface of the display panel, for example, when the viewer is away from a position that is right in front of the display device.

### SUMMARY

One or more embodiments of the present invention may be related to an optical member that may enable a display device to display images with substantially satisfactory quality for one or more viewers at different viewing positions. One or more embodiments of the present invention may be related to a display device that includes the optical member.

One or more embodiments of the invention may be related to an optical member that may include a polarization film that is configured to polarize light according to an axis. The optical member may further include a sealing member that overlaps the polarization film. The optical member may further include a retardation film that is disposed between the polarization film and the sealing member and configured to cause phase retardation. The optical member may further include a lens film that is disposed between the retardation film and the sealing member and includes a plurality of concave lens units. The plurality of concave lens units may define a plurality of air units. The plurality of air units may be sealed by the sealing member. The plurality of concave lens units may diffuse light, such that image color variation potentially caused by viewing angle variation may be minimized.

In one or more embodiments, the lens film may include a base disposed between the retardation film and the plurality of lens unit and having a refractive index in a range of 1.5 to 1.6.

In one or more embodiments, the sealing member may include a pressure sensitive adhesive material.

In one or more embodiments, the sealing member may include two protrusions that are configured to seal two ends of each of the plurality of air units, wherein the plurality of air units may be disposed between the two protrusions.

In one or more embodiments, each concave lens unit of the plurality of concave lens units may extend in a first direction, and each of the two protrusions may extend in a second direction that is perpendicular to the first direction.

In one or more embodiments, the sealing member may include a protrusion that surrounds the plurality of lens units and plurality of air units.

In one or more embodiments, the optical member may further include a light-blocking member that is disposed between the polarization film and the retardation film. The light-blocking member may overlap the protrusion and may be aligned with the protrusion.

In one or more embodiments, the sealing member may include an adhesive member that overlaps the retardation film. The sealing member may further include a protection film that is disposed between the lens film and the adhesive member and is configured to seal the plurality of air units.

In one or more embodiments, the protection film may include at least one of triacetyl cellulose or poly-ethylene terephthalate.

In one or more embodiments, the protection film may include two protrusions that are configured to seal two ends of each of the plurality of air units, wherein the plurality of air units is disposed between the two protrusions.

In one or more embodiments, the protection film may include a first protrusion that surrounds the plurality of lens units and plurality of air units. The protection film may further include a flat portion that is connected to the first protrusion and contacts the plurality of lens units.

In one or more embodiments, the adhesive member may include a second protrusion that surrounds the flat portion of the protection film.

One or more embodiments of the invention may be related to a display device that may include the following elements: a display panel; a polarization film configured to polarize light; a sealing member disposed between the polarization film and the display panel and attached to the display panel; a retardation film disposed between the polarization film and the sealing member and configured to cause phase retardation; and a lens film disposed between the retardation film and the sealing member and including a plurality of concave lens units that extends in a first direction and defines a plurality of air units, the plurality of air units being sealed by the sealing member.

In one or more embodiments, the sealing member may include two protrusions configured to seal two ends of each of the plurality of air units, wherein the plurality of air units is disposed between the two protrusions, and wherein the two protrusions overlap a non-display area of the display panel.

In one or more embodiments, the sealing member may include a protrusion that surrounds the plurality of lens units and plurality of air units, wherein the protrusion overlaps a non-display area of the display panel.

In one or more embodiments, the sealing member may include the following elements: an adhesive member overlapping the retardation film; and a protection film disposed between the lens film and the adhesive member and configured to seal the plurality of air units.

In one or more embodiments, the protection film may include at least one of triacetyl cellulose or poly-ethylene terephthalate.

In one or more embodiments, the protection film may include two protrusions configured to seal two ends of each of the plurality of air units, wherein the plurality of air units is disposed between the two protrusions.

In one or more embodiments, the protection film may include the following elements: a first protrusion that surrounds the plurality of lens units and plurality of air units; and a flat portion that is connected to the first protrusion and contacts the plurality of lens units.

In one or more embodiments, the adhesive member may include a second protrusion that surrounds the flat portion of the protection film.

One or more embodiments of the invention may be related to an optical member that may include the following elements: a lens film, a polarizing film, a retardation film, and an adhesive member. The lens film may include a base (which may have a film shape) and a plurality of lens units disposed on a first side of the base and extending in a predetermined direction. The plurality of lens units may diffuse light, such that image color variation potentially caused by viewing angle variation may be minimized. The polarizing film may be disposed on a second side of the base. The retardation film may be disposed between the base and the polarizing film. The adhesive member may contact the plurality of lens units to form a plurality of air units under the lens units. The adhesive member may include a protrusion protruding toward the polarizing film. The protrusion may seal both ends of each of the air units to isolate the air units from an external environment.

In one or more embodiments, the base may have a refractive index that is in a range of about 1.5 to about 1.6.

In one or more embodiments, the adhesive member includes a pressure sensitive adhesive material.

In one or more embodiments, the protrusion is formed along an edge of the base, and the lens film is disposed in a space defined by the protrusion.

In one or more embodiments, the protrusion may be disposed at two edges of the base that are perpendicular to the extending direction of the air units.

In one or more embodiments, the optical member may include a protection film that is disposed between the base and the adhesive member, and the protection film may include triacetyl cellulose and/or poly-ethylene terephthalate.

One or more embodiments of the invention may be related to a display device that includes a display panel and an optical member attached to the display panel. The optical member may have one or more of the above-mentioned features.

### BRIEF DESCRIPTION OF THE DRAWINGS

FIG. 1 is a perspective view illustrating a display device according to an embodiment of the present invention;

FIG. 2 is a cross-sectional view illustrating the display device illustrated in FIG. 1;

FIG. 3 is an exploded perspective view illustrating an optical member illustrated in FIG. 1;

FIG. 4 is a cross-sectional view taken along a line I-I′ indicated in FIG. 3;

FIG. 5 is a partially enlarged view illustrating a portion “A” indicated in FIG. 4;

FIG. 6 is a simulation graph illustrating brightness ratios at various viewing angles according to a first comparison example, a second comparison example, and a first embodiment example;

FIG. 7 is a graph illustrating measured values of a color shift at various viewing angles according to the first comparison example, the second comparison example, and the first embodiment example;

FIG. 8 is an exploded perspective view illustrating an optical member according to an embodiment of the present invention;

FIG. 9 is a cross-sectional view taken along a line II-II′ indicated in FIG. 8;

FIG. 10 is an exploded perspective view illustrating an optical member according to an embodiment of the present invention; and

FIG. 11 is a cross-sectional view taken along a line III-III′ indicated in FIG. 10.

### DETAILED DESCRIPTION

In this application, when an element or layer is referred to as being “on”, “connected to”, or “coupled to” another element or layer, it can be directly on, directly connected, or directly coupled to the other element or layer, or intervening elements or layers may be present. In contrast, when an element is referred to as being “directly on,” “directly connected to”, or “directly coupled to” another element or layer, there are no intervening elements or layers (except environmental elements such as air) present. Like numbers may refer to like elements. The term “and/or” may include any and all combinations of one or more of the associated listed items.

Although the terms first, second, etc. may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present invention. The description of an element as a “first” element may not require or imply the presence of a second element or other elements. The terms first, second, etc. may also be used herein to differentiate different categories of elements. For conciseness, the terms first, second, etc. may represent first-type (or first-category), second-type (or second-category), etc., respectively.

For conciseness, “connected” may mean “electrically connected”; “insulated” may mean “electrically insulated”.

Spatially relative terms, such as “beneath”, “below”, “lower”, “above”, “upper”, and the like, may be used herein for ease of description to describe relationship between elements or between features illustrated in the figures. The spatially relative terms may encompass different orientations of the device in use or operation in addition to the orientation depicted in the figures. For example, if the device illustrated in a figure is turned over, elements described as “below” or “beneath” other elements or features would then be oriented “above” the other elements or features. Thus, the term “below” can encompass both an orientation of above and below. The device may be otherwise oriented (e.g., rotated by 90 degrees or at other orientations), and the spatially relative descriptors may be adjusted accordingly.

The terminology used herein is for the purpose of describing particular embodiments only and is not intended to be limiting of the invention. As used herein, the singular forms, “a”, “an”, and “the” may include plural forms as well, unless the context clearly indicates otherwise. The terms “includes” and/or “including”, when used in this specification, specify the presence of stated features, integers, steps, operations, elements, and/or components, but do not preclude the presence or addition of one or more other features, integers, steps, operations, elements, components, and/or groups.

Unless otherwise defined, terms (including technical and scientific terms) used herein have the same meaning as commonly understood by one of ordinary skill in the art to which this invention belongs. Terms, such as those defined in commonly used dictionaries, should be interpreted as having a meaning that is consistent with their meaning in the context of the relevant art and should not be interpreted in an idealized or overly formal sense unless expressly so defined herein.

Hereinafter, the present invention will be explained in detail with reference to the accompanying drawings.

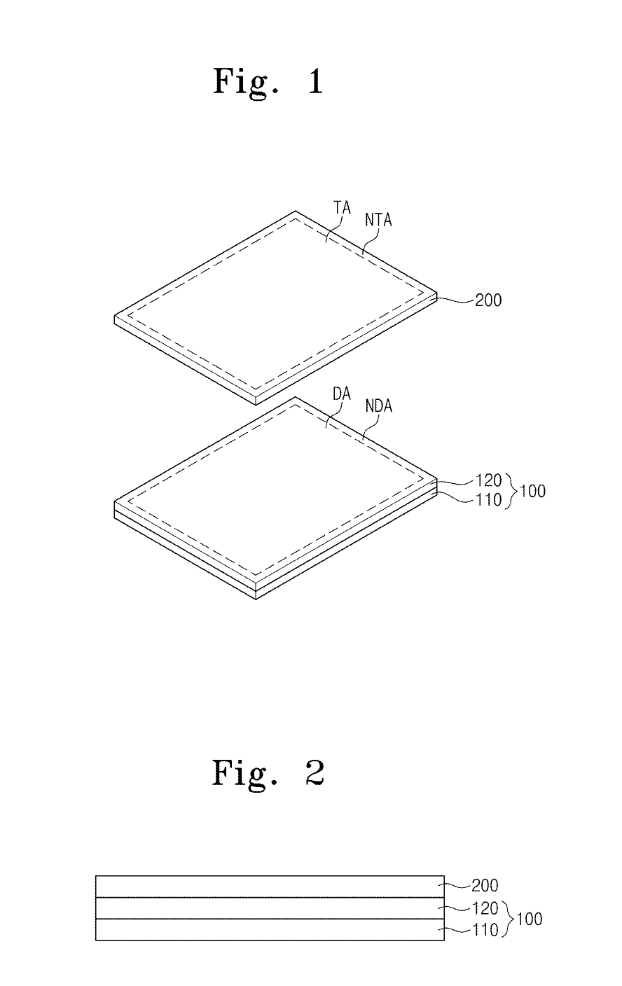

FIG. 1 is a perspective view illustrating a display device according to an embodiment of the present invention. FIG. 2 is a cross-sectional view illustrating the display device illustrated in FIG. 1.

Referring to FIGS. 1 and 2, the display device includes a display panel 100 and an optical member 200 overlapping the display panel 100.

The display panel 100 includes a display area DA that may display an image and a non-display area NDA that is disposed adjacent to the display area DA. The display panel 100 may be a self-emissive display panel (e.g., an organic light emitting display panel) or a non-self-emissive display panel (e.g., one of a liquid crystal display panel, an electrophoretic display panel, an electrowetting display panel, etc.). In an embodiment, the display panel 100 is a non-self-emissive display panel, and the display device may further include a backlight unit to supply a light to the display panel 100. In an embodiment, the display panel 100 may be an organic light emitting display panel.

The display panel 100 includes a display substrate 110 and an opposite substrate 120.

The display substrate 110 may include at least one thin film transistor (not shown) disposed on a base substrate and an organic light emitting device (not shown) connected to the thin film transistor.

The base substrate includes a transparent insulating material configured to transmit light. The base substrate may be a rigid type substrate or a flexible type substrate. The rigid type substrate may be a glass substrate, a quartz substrate, a glass ceramic substrate, or a crystalline glass substrate. The flexible type substrate may be a film substrate or a plastic substrate and may contain an organic polymer. The material used to form the base substrate may have a sufficient heat resistance, such that the display device may be manufactured at a high process temperature.

The thin film transistor may apply an input signal to the organic light emitting device to allow the organic light emitting device to emit light. The thin film transistor includes a semiconductor layer, a gate electrode, a source electrode, and a drain electrode.

The organic light emitting device may directly contact the drain electrode. In an embodiment, the organic light emitting device includes a first electrode directly contacting the drain electrode, an organic layer disposed on the first electrode, and a second electrode disposed on the organic layer. One of the first electrode and the second electrode is an anode electrode, and the other one of the first electrode and the second electrode is a cathode electrode. At least one of the first electrode and the second electrode may be transparent.

The first electrode may be a conductive layer containing a transparent conductive oxide, such as indium tin oxide (ITO), indium zinc oxide (IZO), aluminum zinc oxide (AZO), gallium-doped zinc oxide (GZO), zinc tin oxide (ZTO), gallium tin oxide (GTO), or fluorine-doped tin oxide (FTO). The second electrode may reflect light and may contain at least one of Mo, MOW, Cr, Al, AlNd, and Al alloy.

The organic layer includes a light emitting layer and may have a multi-layer structure. In an embodiment, the organic layer may include a hole injection layer that may injects holes. The organic layer may further include a hole transport layer that may control movement of electrons that are have not been combined with the holes in the light emitting layer, to enhance an opportunity of recombination between holes and electrons. The light emitting layer may emit light as a result of combination and recombination between holes and electrons, which are injected into the light emitting layer. The organic layer may further include a hole blocking layer that may control movement of holes that have not been combined or recombined with electrons in the light emitting layer. The organic layer may further include an electron transport layer that may transport electrons to the light emitting layer. The organic layer may further include an electron injection layer that may inject electrons.

The opposite substrate 120 isolates the organic light emitting device from an external environment and is coupled to the display substrate 110 using a sealant. The opposite substrate 120 may include the same material as the base substrate.

The optical member 200 may be disposed in a direction in which the light exiting from the display panel 100 travels and may overlap the display panel 100. In an embodiment, the opposite substrate 120 may be disposed between the display substrate 110 and the optical member 200. The optical member 200 may include a transmission area TA configured to transmit the light and may include a non-transmission area NTA disposed adjacent to (e.g., surrounding) the transmission area TA. In an embodiment, the transmission area TA corresponds to the display area DA, and the non-transmission area NTA corresponds to the non-display area NDA.

The optical member 200 may provide a viewer, who watches the display device, with a wide viewing angle. The optical member 200 may diffuse the light that exits from the display panel 100 and has a high linearity.

Thus, the display device, which includes the optical member 200, may provide the viewer with images having satisfactory display quality at various viewing angles.

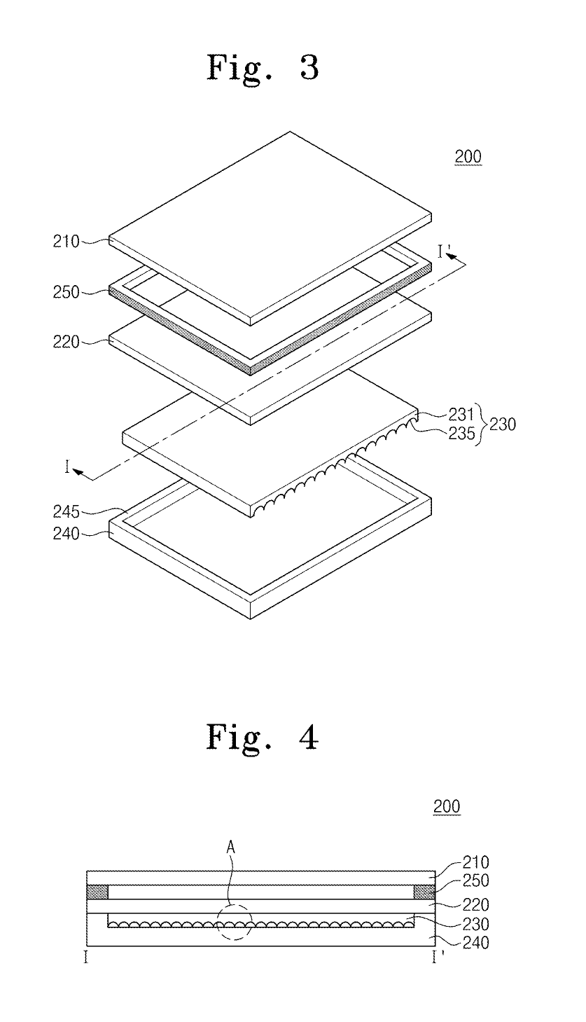

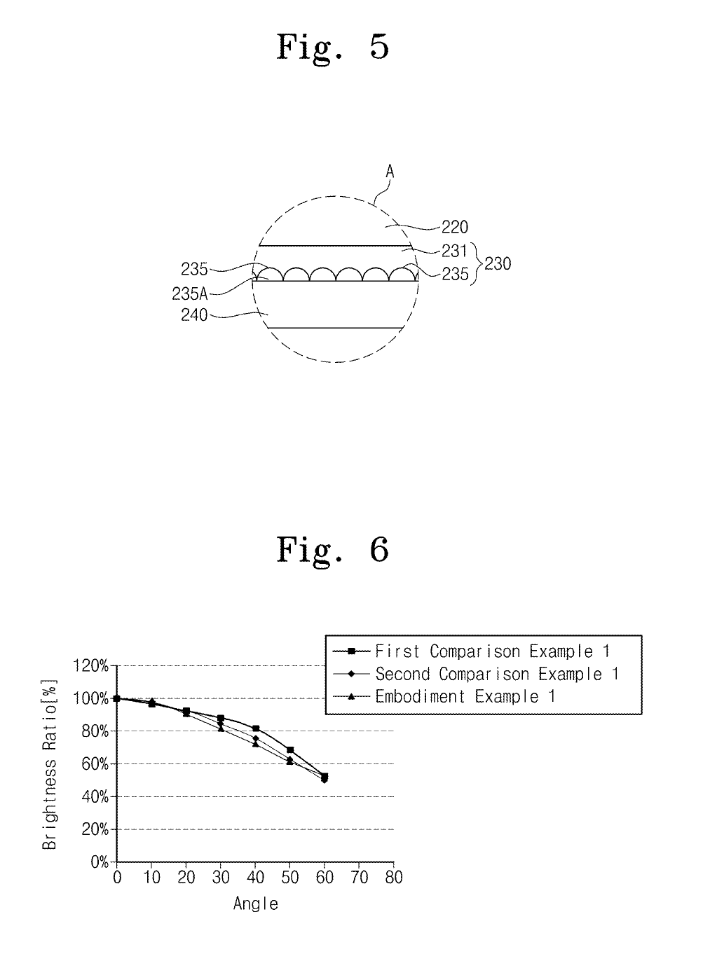

FIG. 3 is an exploded perspective view illustrating the optical member 200 illustrated in FIG. 1. FIG. 4 is a cross-sectional view taken along a line I-I′ indicated in FIG. 3. FIG. 5 is a partially enlarged view illustrating a portion “A” indicated in FIG. 4.

Referring to FIGS. 1 to 5, the optical member 200 is disposed on a display surface of the display panel 100, from which the light generated by the organic light emitting device exits.

The optical member 200 includes the transmission area TA configured to transmit the light and includes the non-transmission area NTA disposed adjacent to (and surrounding) the transmission area TA. In addition, the optical member 200 includes a viewing angle enhancement film 230 (or lens film 230), a polarizing film 210 overlapping the viewing angle enhancement film 230, a retardation film 220 disposed between the viewing angle enhancement film 230 and the polarizing film 210, and an adhesive member 240 (or sealing member 240) overlapping the viewing angle enhancement film 230 for attaching the optical member 200 to the display panel 100.

The viewing angle enhancement film 230 includes a base 231 having a film shape and includes a plurality of (concave) lens units 235 disposed on a first surface of the base 231. Light may enter the viewing angle enhancement film 230, processed by the lens units 235, and exits from the base 231.

The base 231 includes a transparent polymer resin, e.g., an ultraviolet-ray curing transparent resin. The base 231 may have a refractive index that is in a range of about 1.5 to about 1.6. The base 231 may have a thickness that is in a range of about 80 micrometers to about 120 micrometers.

The lens units 235 may diffuse the light exiting from the display panel 100. The lens units 235 extend in a direction that is substantially parallel to or is inclined with respect to a side of the base 231.

The polarizing film 210 is disposed on a second surface of the base 231 that is opposite the first surface of the base 231. The polarizing film 210 has a transmission axis for transmit light components in a specific direction.

The retardation film 220 is disposed between the base 231 and the polarizing film 210. The retardation film 220 has a retardation difference of about λ/4, wherein λ is a wavelength of the light received by the retardation film 220.

The polarizing film 210 and the retardation film 220 may prevent an image displayed by the display device from being substantially affected by an external light incident to the display device and reflected by the display panel 100.

The polarizing film 210 may transmit only light components of the external light that are parallel to the transmission axis of the polarizing film 210. The retardation film 220 may retard a phase of the light components received from the polarizing film 210 by about λ/4 to output first retarded light. The first retarded light output by the retardation film 220 may be reflected by the display panel 100, such that the display panel 100 may provide reflected light toward the retardation film 220. The retardation film 220 may retard the phase of the reflected light by about λ/4 to output second retarded light. As a result, the second retarded light may be substantially vertical to the transmission axis of the polarizing film 210. Thus, the second retarded light may not be transmitted through the polarizing film 210.

Therefore, the effect of the external light on the displayed image may be minimized or eliminated. Advantageously, consistent and satisfactory quality of the displayed image may be provided.

A first portion of the adhesive member 240 may surround the base 231. The lens units 235 and air units 235A formed under the lens units 235 may be disposed between a second portion of the adhesive member 240 and the base 231. The air units 235A are filled with air. The lens units 235, which may be concave lenses, may diffuse the light provided by the display panel 100.

The adhesive member 240 may include a pressure sensitive adhesive material PSA that may transmit light and may be waterproof or water-resistant. For instance, the adhesive member 240 includes at least one of acryl-based adhesive, silicon-based adhesive, urethane-based adhesive, polyvinylbutyral adhesive (PMB), ethylene vinyl acetate (EVA) adhesive, polyvinylether (PVE) adhesive, saturated amorphous polyester adhesive, and melamine resin adhesive.

The second portion of the adhesive member 240 may be attached to the display panel 100. Accordingly, the optical member 200 may be affixed to the display panel 100.

The first portion of the adhesive member 240 may include protrusions 245 formed along edges of the second portion of the adhesive member 240, and the viewing angle enhancement film 230 is disposed in a space defined by the protrusions 245. The protrusions 245 may seal both ends of each of the air units 235A to isolate the air units 235A from the external environment. The first portion of the adhesive member 240 (e.g., the protrusions 245) may overlap and may be aligned with the non-display area NDA of the display panel 100.

The optical member 200 may further include a black pattern layer 250 (or light-blocking member 250) that defines the non-transmission area NTA. The transmission area TA and the non-transmission area NTA may be distinct from each other according to the black pattern layer 250.

The black pattern layer 250 may overlap (and may be aligned with) the non-display area NDA of the display panel 100, the first portion (e.g., the protrusion 245) of the adhesive member 240, and/or an edge portion of the polarizing film 210. The black pattern layer 250 may be disposed between the polarizing film 210 and the retardation film 220 or between the retardation film 220 and the viewing angle enhancement film 230.

The viewing angle enhancement film 230 of the optical member 200 may diffuse the light provided from the display panel 100. Advantageously, the display device may provide a substantially wide viewing angle for the viewer.

The adhesive member may prevent moisture from infiltrating into the air units 235A. Advantageously, consistent and satisfactory performance of the lens units 235 of the viewing angle enhancement film 230 may be maintained.

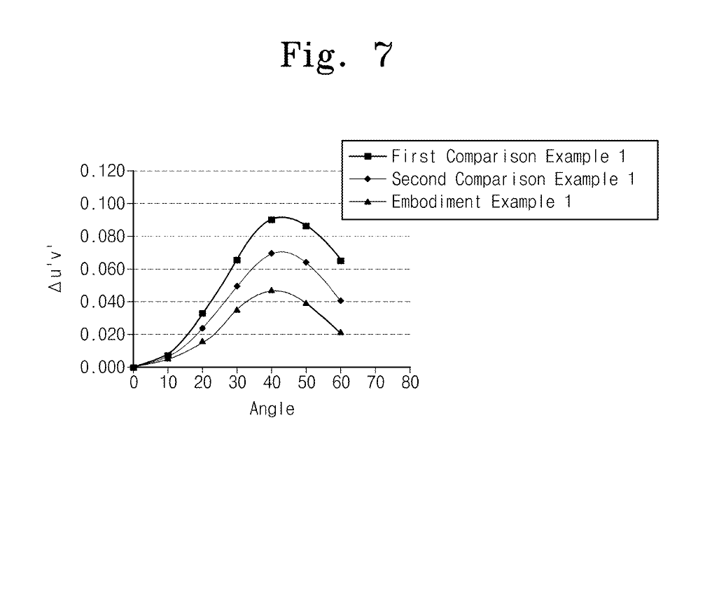

FIG. 6 is a simulation graph illustrating brightness ratios at various viewing angles according to a first comparison example, a second comparison example, and a first embodiment example. FIG. 7 is a graph illustrating measured values of a color shift at various viewing angles according to the first comparison example, the second comparison example, and the first embodiment example.

The first comparison example is associated with a display device that does not include the optical member 200 illustrated in FIGS. 1 to 5, the second comparison example is associated with a display device that includes an optical member in which air units are filled with an adhesive material, and the first embodiment example is associated with the display device that includes the optical member 200 illustrated in FIGS. 1 to 5. The base 231 of the optical member 200 has a refractive index of about 1.59, and the adhesive member 240 has a refractive index of about 1.39.

Referring to FIG. 6, brightness variation according to the first comparison example, brightness variation according to the second comparison example, and brightness variation according to the first embodiment example are similar to each other. In each of the examples, the brightness at the viewing angle of about 60 degrees is reduced to about 50% in comparison with the brightness at the viewing angle of about 0 degree. The viewing angle of 0 degree means that viewer views the displayed image in a first direction that is perpendicular to the display panel. The viewing angle of 60 degrees means that the viewer views the displayed image in a second direction that is at an angle of 60 degrees with respect to the first direction.

Referring to FIG. 7, a maximum color difference is observed at the viewing angle of about 40 degrees in each of the first comparison example, the second comparison example, and the first embodiment example.

The color difference of the first embodiment example is substantially smaller than that of each of the first comparison example and the second comparison example. That is, variation in color associated with change of viewing angle is substantially smaller in the first embodiment example than those in the comparison examples. In other words, the display device including the optical member 200 illustrated in FIGS. 1 to 5 may display images with consistent colors for one or more viewers at different viewing positions, such that consistent and satisfactory image quality may be provided.

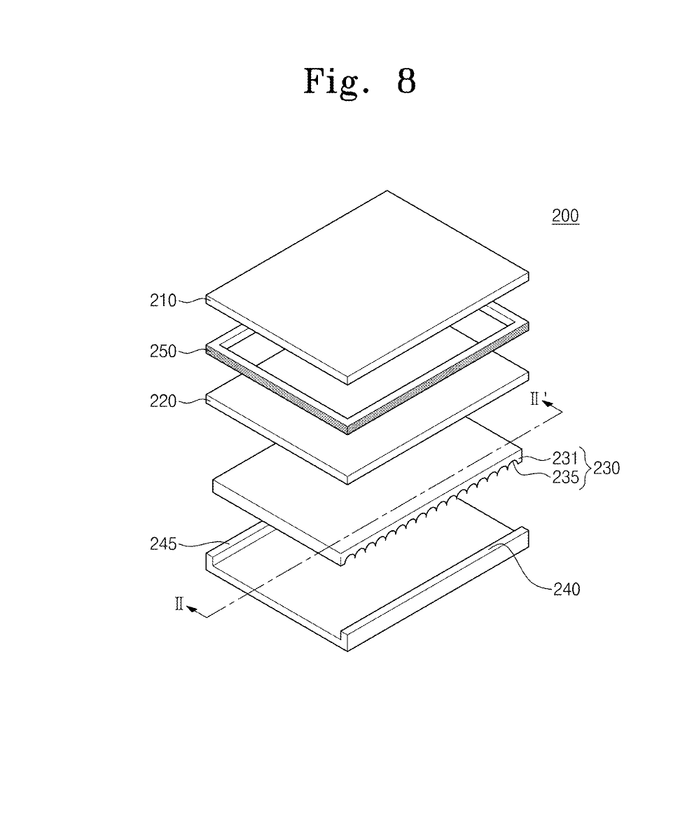

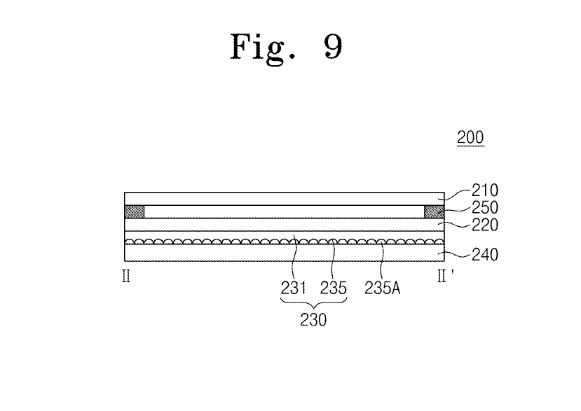

FIG. 8 is an exploded perspective view illustrating an optical member according to an embodiment of the present invention. FIG. 9 is a cross-sectional view taken along a line II-II′ indicated in FIG. 8. In FIGS. 8 and 9, the same reference numerals may denote the same elements or analogous elements illustrated in FIGS. 1 to 5,

Referring to FIGS. 1, 2, 8, and 9, the optical member 200 may be disposed on a display surface of the display panel 100 that emits light.

The optical member 200 includes the viewing angle enhancement film 230, the polarizing film 210 disposed overlapping the viewing angle enhancement film 230, the retardation film 220 disposed between the viewing angle enhancement film 230 and the polarizing film 210, and the adhesive member 240 disposed between the retardation film 220 and the display panel 100 for attaching the optical member 200 to the display panel 100.

The viewing angle enhancement film 230 includes the base 231 and the lens units 235 disposed between the base 231 and the display panel 100.

The lens units 235 may diffuse the light provided from the display panel 100. The lens units 235 may extend in a direction that is substantially parallel to or inclined with respect to an edge of the base 231.

The base 231 is disposed between the lens units 235 and the polarizing film 210. The retardation film 220 is disposed between the base 231 and the polarizing film 210. The polarizing film 210 has a transmission axis and is configured to transmit light components in a specific direction. The retardation film 220 has the retardation difference of about λ/4.

The lens units 235 are disposed between a first portion of the adhesive member 240 and the base 231. Air units 235A may be formed between the first portion of the adhesive member 240 and the viewing angle enhancement film 230, with shapes of the air units 235A being defined by the lens units 235.

The adhesive member 240 may include two protrusions 245 protruding from the first portion of the adhesive member 240 toward the polarizing film 210. The lens units 235 and the air units 235A may be disposed between the two protrusions 245. The two protrusions 245 may correspond to two edges of the base 231, at which the air units 235A are exposed. The two protrusions 245 may seal the two ends of each of the air units 235A. Therefore, the protrusions 245 of the adhesive member 240 may isolate the air units 235A from the external environment.

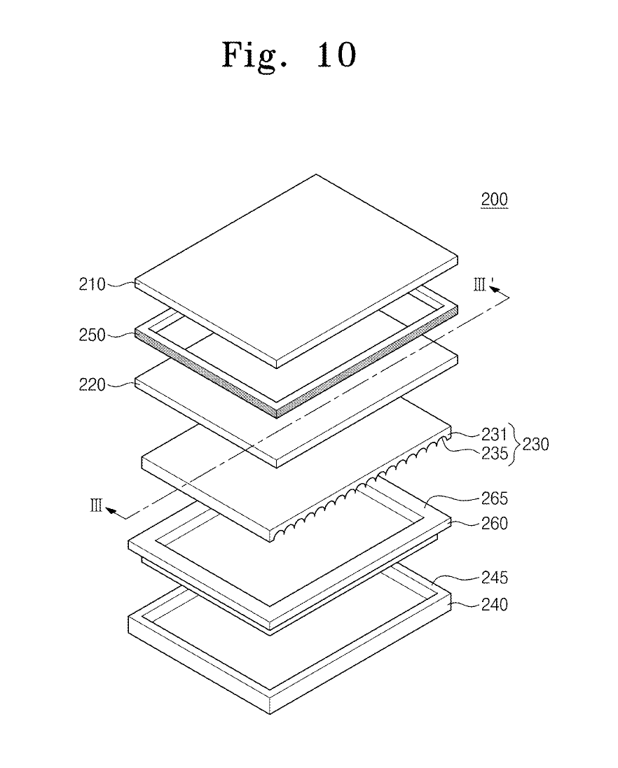

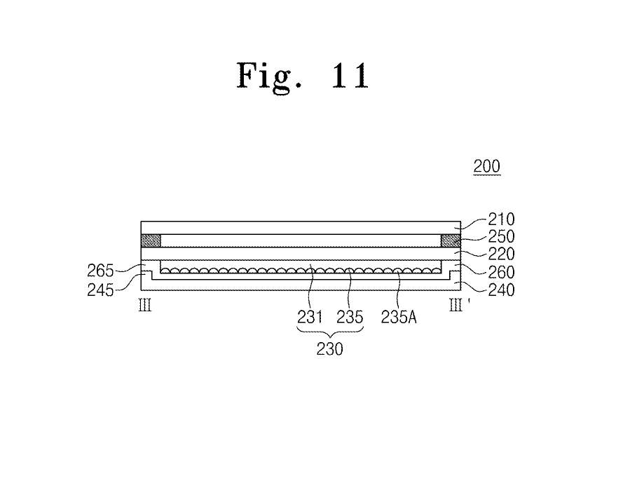

FIG. 10 is an exploded perspective view illustrating an optical member according to an embodiment of the present invention and FIG. 11 is a cross-sectional view taken along a line III-III′ indicated in FIG. 10. In FIGS. 10 to 11, the same reference numerals may denote the same elements or analogous elements illustrated in FIGS. 1 to 5,

Referring to FIGS. 1, 2, 10, and 11, the optical member 200 may be disposed on a display surface of the display panel 100 that emits light.

The optical member 200 includes the viewing angle enhancement film 230, the polarizing film 210 overlapping the viewing angle enhancement film 230, the retardation film 220 disposed between the viewing angle enhancement film 230 and the polarizing film 210, the adhesive member 240 disposed between the retardation film 220 and the display panel for attaching the optical member 200 to the display panel 100, and a protection film 260 disposed between the viewing angle enhancement film 230 and the adhesive member 240.

The viewing angle enhancement film 230 includes the base 231 and the lens units 235 disposed between the base 231 and the display panel 100.

The lens units 235 may diffuse the light provided from the display panel 100. The lens units 235 may extend in a direction that is substantially parallel to or inclined with respect to an edge of the base 231.

The base 231 is disposed between the lens units 235 and the polarizing film 210. The retardation film 220 is disposed between the base 231 and the polarizing film 210. The polarizing film 210 has a transmission axis and is configured to transmit light components in a specific direction. The retardation film 220 has the retardation difference of about λ/4.

The lens units 235 are disposed between a first portion of the adhesive member 240 and the base 231. Air units 235A may be formed between the first portion of the adhesive member 240 and the viewing angle enhancement film 230, with shapes of the air units 235A being defined by the lens units 235.

The adhesive member 240 includes protrusions 245 formed along edges of the other surface of the base 231. The protrusions 245 may surround at least a portion of the lens units 235 and at least a portion of the air units 235A.

The protection film 260 is disposed between the adhesive member 240 and the viewing angle enhancement film 230 to protect the lens units 235. The protection film 260 is disposed on the adhesive member 240. The protection film 260 may include triacetyl cellulose (TAC) or polyethylene terephthalate (PET).

The protection film 260 includes second protrusions 265 corresponding to, overlapping, contacting, and/or matching the protrusions 245. The second protrusions 265 of the protection film 260 are formed along edges of the base 231. The protrusions 245 of the adhesive member 240 may surround the lens units 235 and the air units 235A. The protrusions 265 may overlap and may be aligned with the non-display area NDA of the display panel 100. The protection film 260 and the adhesive member 240 may form a sealing member that seals the air units 235A.

The lens units 235 are disposed on a flat portion of the protection film 260 that is connected to the second protrusions 265 of the protection film 260. The flat portion of the protection film 260 may be surrounded by the protrusions 245 of the adhesive member 240. The viewing angle enhancement film 230 is disposed in the space defined by the second protrusions 265. The retardation film 220 may be disposed on and may contact the second protrusions 265. The protection film 260 may isolate the air units 235A from the external environment.

Although embodiments of the present invention have been described, it is understood that the present invention should not be limited to these embodiments. Various changes and modifications can be made by one ordinary skilled in the art within the spirit and scope of the present invention as hereinafter claimed.

What is claimed is:

1. An optical member comprising:
a polarization film configured to polarize light;
a sealing member overlapping the polarization film;
a retardation film disposed between the polarization film and the sealing member and configured to cause phase retardation; and
a lens film disposed between the retardation film and the sealing member and comprising a plurality of concave lens units that defines a plurality of air units, the plurality of air units being sealed by the sealing member.

2. The optical member of claim 1, wherein the lens film comprises a base disposed between the retardation film and the plurality of lens unit and having a refractive index in a range of 1.5 to 1.6.

3. The optical member of claim 1, wherein the sealing member comprises a pressure sensitive adhesive material.

4. The optical member of claim 1, wherein the sealing member comprises two protrusions configured to seal two ends of each of the plurality of air units, and wherein the plurality of air units is disposed between the two protrusions.

5. The optical member of claim 4, wherein each concave lens unit of the plurality of concave lens units extends in a first direction, and wherein each of the two protrusions extends in a second direction that is perpendicular to the first direction.

6. The optical member of claim 1, wherein the sealing member comprises a protrusion that surrounds the plurality of lens units and plurality of air units.

7. The optical member of claim 6, further comprising a light-blocking member disposed between the polarization film and the retardation film, the light-blocking member overlapping the protrusion and being aligned with the protrusion.

8. The optical member of claim 1, wherein the sealing member comprises:
an adhesive member overlapping the retardation film; and
a protection film disposed between the lens film and the adhesive member and configured to seal the plurality of air units.

9. The optical member of claim 8, wherein the protection film comprises at least one of triacetyl cellulose or poly-ethylene terephthalate.

10. The optical member of claim 8, wherein the protection film comprises:
a first protrusion that surrounds the plurality of lens units and plurality of air units; and
a flat portion that is connected to the first protrusion and contacts the plurality of lens units.

11. The optical member of claim 10, wherein the adhesive member comprises a second protrusion that surrounds the flat portion.

12. A display device comprising:
a display panel;
a polarization film configured to polarize light;
a sealing member disposed between the polarization film and the display panel;
a retardation film disposed between the polarization film and the sealing member and configured to cause phase retardation; and
a lens film disposed between the retardation film and the sealing member and including a plurality of concave lens units that extends in a first direction and defines a plurality of air units, the plurality of air units being sealed by the sealing member.

13. The display device of claim 12, wherein the sealing member comprises two protrusions configured to seal two ends of each of the plurality of air units, wherein the plurality of air units is disposed between the two protrusions, and wherein the two protrusions overlap a non-display area of the display panel.

14. The display device of claim 12, wherein the sealing member comprises a protrusion that surrounds the plurality of lens units and plurality of air units, and wherein the protrusion overlaps a non-display area of the display panel.

15. The display device of claim 12, wherein the sealing member comprises:
an adhesive member overlapping the retardation film; and
a protection film disposed between the lens film and the adhesive member and configured to seal the plurality of air units.

16. The display device of claim 15, wherein the protection film comprises at least one of triacetyl cellulose or poly-ethylene terephthalate.

17. The display device of claim 15, wherein the protection film comprises:
a first protrusion that surrounds the plurality of lens units and plurality of air units; and
a flat portion that is connected to the first protrusion and contacts the plurality of lens units.

18. The display device of claim 17, wherein the adhesive member comprises a second protrusion that surrounds the flat portion.
